(19) United States
(12) Patent Application Publication
(10) Pub. No.: US 2018/0290449 A1
(43) Pub. Date: Oct. 11, 2018

(54) ADHESION AND INSULATING LAYER

(71) Applicant: HEWLETT-PACKARD DEVELOPMENT COMPANY, L.P., Houston, TX (US)

(72) Inventors: Lawrence H. White, Corvallis, OR (US); David R. Thomas, Corvallis, OR (US); Claire O'Cull, Corvallis, OR (US); Michael Hager, Corvallis, OR (US)

(73) Assignee: HEWLETT-PACKARD DEVELOPMENT COMPANY, L.P., Houston, TX (US)

(21) Appl. No.: 15/570,675

(22) PCT Filed: Jul. 15, 2015
(86) PCT No.: PCT/US2015/040630

§ 371 Date: Oct. 30, 2017

(51) Int. Cl. B41J 2/14; B41J 2/16

(52) U.S. Cl. CPC B41J 2/14129; B41J 2/14201; B41J 2/1607; B41J 2/1601; B41J 2/164

(57) ABSTRACT

A fluid ejection device includes a substrate; a plurality of resistors on the substrate with separation of between 4 and 8 microns between adjacent resistors; an adhesion layer applied over the plurality of resistors; and a layer of silicon carbide (SiC) applied directly over the adhesion layer such that the silicon carbide is between adjacent resistors. A method of forming a fluid ejection device includes forming resistors and conductive traces attached to a substrate; depositing an adhesion layer over the resistors; depositing a silicon carbide (SiC) coating directly over the adhesion layer; and forming an epoxy layer over silicon carbide layer.

### BACKGROUND

Printheads used in thermal inkjet (TIJ) printers may include die with the ink ejectors and/or control components. The die includes a substrate which is built up layer by layer using semiconductor fabrication techniques. This allows for the integration of control components directly into the substrate. The die may also include a number microelectromechanical systems (MEMS). These may include ejector ports and printing fluid distribution systems built up on the die. Creating these features may require a number of complex manufacturing processes.

### BRIEF DESCRIPTION OF THE DRAWINGS

The accompanying drawings illustrate various examples of the principles described herein and are a part of the specification. The illustrated examples are merely illustrative and do not limit the scope of the claims. Like numerals denote like but not necessarily identical elements.

FIG. 1 shows an example or a fluid ejection system suitable for implementing a fluid ejection device with a silicon carbide (SiC) barrier layer.

FIG. 2 shows an example of a fluid supply device implemented as an ink cartridge.

FIG. 3 shows a plan view of an illustrative assembly according to principles described herein.

FIG. 4A shows the purposes of the layers of the assembly of FIG. 3.

FIG. 4B shows a specific examples of each of the identified layers of FIG. 4A.

FIG. 5 shows a flowchart of an illustrative production process.

FIG. 6 shows a flowchart of another illustrative production process.

Throughout the drawings, identical reference numbers designate similar, but not necessarily identical, elements.

### DETAILED DESCRIPTION

Printing fluids include a variety of components that may damage parts of a printing system, particularly under the conditions wherein such fluids are used. For example, the ejector elements and chambers are susceptible to damage due to the high temperatures, pressures, and thermal stresses produced during printing fluid ejection.

In a thermal inkjet (TIJ) printhead, a portion of the printing fluid is rapidly vaporized to form a bubble. The bubble expands and ejects a portion of the ink in the chamber from the nozzle. The bubble then collapses. The result is that printing fluid in the printing chamber is heated to at least boiling (just over 100C for water based printing fluids). The printing fluid may include oxygen and halogens such as chloride which contribute to chemical reactions and degradation of materials, The result is that printing fluids in TIJ ejection chambers can be unexpectedly corrosive due to the heat and energy available to drive degradation reactions. Further, since a printer can fire thousands of times to print a single document, a printhead can be exposed to these conditions millions of times during its functional life.

Piezoelectric inkjet (PIJ) printheads use the expansion of a piezoelectric element to drive the ejection of ink from a printing chamber. While heating does not occur as in a TIJ, a PIJ still has to provide for chemical compatibility between the printhead and the printing fluid.

One component used in fabrication of print heads that has potential for chemical reaction with printing fluids, including inks, is silicon nitride (SiN). Silicon nitride may be used as an insulating layer in a print head. Silicon nitride provides greater dielectric strength and reduced current leakage compared with alternate materials including silicon carbide (SiC). However, exposure of the SiN to printing fluids may result in erosion of the SiN layer. Accordingly, when an SiN layer is used, it imposes design constraints to prevent contact with the printing fluid. In some designs, the outer surface is coated with the more chemically inert SiC.

However, during processing it is often necessary to etch or cut through the SiN/SiC layers. Such etching may allow the firing resistors on the printhead to contact the printing fluid. In areas where such cuts are made, they may expose the SiN layer to contact with the printing fluid. As a result, additional steps or design restrictions may be needed to prevent printing fluid contact with the SiN layer.

For instance, some features may be resized to allow room for an epoxy layer to cover the exposed SiN. Alternately, the SiN may be etched back prior to the SiC coating. Thus, while the use of a combined SiN/SiC layer has been found effective, it imposes additional manufacturing steps and costs on device production.

Experimentation has found that it is possible to use a thin SiC-only layer without a SiN layer to function as an insulator in some designs. The thinner SiC-only barrier layer does not have the same insulating capability of the thicker combination SiN/SiC layer. However, in some geometries, such as where elements are spaced at least 4 microns apart laterally (up to about 10 micron minimum separation), the insulation of the SiC alone is adequate to allow the system to function with acceptable leakage currents between adjacent elements.

In one example, the use of an SiC-only barrier layer resulted in a leakage current between adjacent elements of less than 10E-10 Amps. Such a system has the twin advantages of removing a step from the processing (SiN deposition) and providing a thinner and more conformal coating to the insulated elements. Such a thinner layer may allow built up epoxy to penetrate into the space between firing resistors. Further, the thickness of the SiC-only layer can be tuned to reduce reflections during processing of subsequent layers. This is advantageous, for example, when building up epoxy based firing chambers and/or nozzles above the firing resistors.

Accordingly, the present specification describes a semiconductor device that includes a substrate; a plurality of resistors on the substrate with separation of between 4 and 8 microns between adjacent resistors; an adhesion layer applied over the plurality of resistors; and a layer of silicon carbide (SiC) applied directly over the adhesion layer such that the silicon carbide is between adjacent resistors.

In another example, the present specification describes a method of forming a fluid ejection device that includes forming resistors and conductive traces attached to a substrate; depositing an adhesion layer over the resistors; depositing a silicon carbide (SiC) coating directly over the adhesion layer; and forming an epoxy layer over silicon carbide layer.

In another example, the present specification describes a printhead for a printer, the printhead including a silicon substrate; firing resistors built up on the silicon substrate with a separation of 4 to 8 microns between adjacent firing resistors, the firing resistors comprising a cavitation barrier layer of tantalum; an adhesion layer applied directly over the cavitation barrier layer; a silicon carbide (SiC) layer applied directly over the adhesion layer; and an epoxy layer comprising firing chambers applied over the silicon carbide layer.

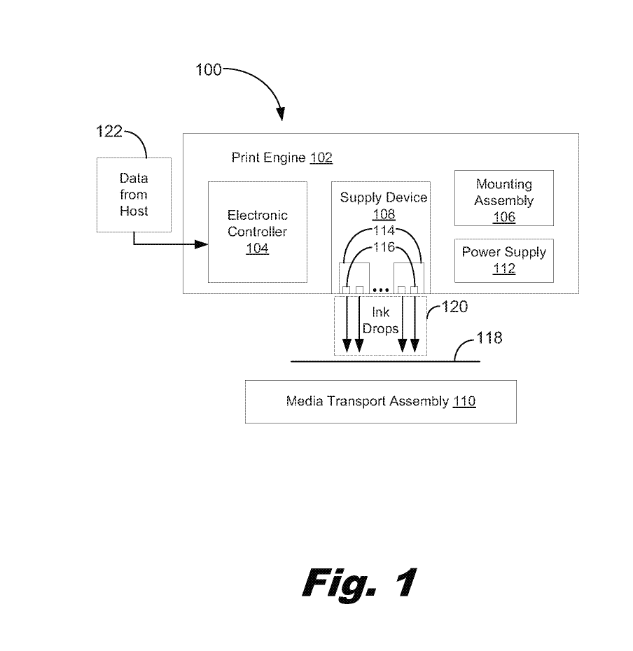

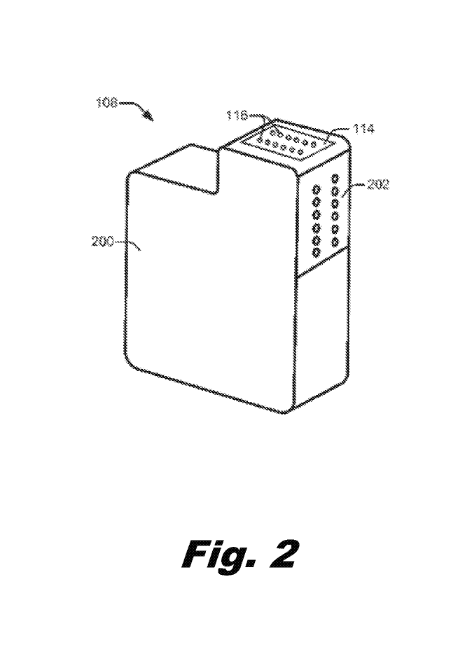

FIG. 1 shows an example of a fluid ejection system 100 suitable for implementing a fluid ejection device having an SiC-only barrier layer as described herein. In this example, the fluid ejection system 100 is an inkjet printing system 100 that includes a print engine 102 having a controller 104, a mounting assembly 106, one or more replaceable fluid supply devices 108 (e.g., FIG. 2), a media transport assembly 110, and at least one power supply 112 that provides power to the various electrical components of inkjet printing system 100. The inkjet printing system 100 further includes one or more fluid ejection devices 114 implemented as printheads 114 that eject drops of ink or other printing fluid through a plurality of nozzles 116 (also referred to as orifices or bores) toward a print media 118.

The ejected drops form a desired image on the print media 118. Print media 118 can be any type of suitable sheet or roll material, such as paper, card stock, transparencies, Mylar, polyester, plywood, foam board, fabric, canvas, and the like,

In some examples, a printhead 114 may be an integral part of a supply device 108, while, in other examples, the printhead 114 may be mounted on a print bar (not shown) of mounting assembly 106 and coupled to a supply device 108 (e.g., via a tube).

In the example of FIG. 1, the printhead 114 is a thermal-inkjet (TIJ) printhead 114. In TIJ printheads 114, electric current is passed through a resistor element to generate heat in a fluid-filled chamber. The heat vaporizes a small quantity of printing fluid 320, creating a rapidly expanding vapor bubble 322 that forces a fluid drop 324 out of a nozzle 116, Following drop ejection, the drive bubble will collapse on the resistor creating a low pressure zone. Refill printing fluid flows into the chamber and cools the chamber. Nozzles 116 may be arranged in columns or arrays along printhead 114 such that properly sequenced ejection of ink from nozzles 116 causes characters, symbols, and/or other graphics or images to be printed on print media 118 as the printhead 114 and/or print media 118 are moved relative to each other.

Mounting assembly 106 positions the printhead 114 relative to media transport assembly 110, and media transport assembly 110 positions print media 118 relative to printhead 114. Thus, a print zone 120 is defined adjacent to nozzles 116 in an area between printhead 114 and print media 118. In one example, print engine 102 is a scanning type print engine. As such, mounting assembly 106 includes a carriage for moving printhead 114 relative to media transport assembly 110 to scan print media 118. In another example, print engine 102 is a non-scanning type print engine, such as a full page width printhead. As such, mounting assembly 106 fixes printhead 114 at a prescribed position relative to media transport assembly 110 while media transport assembly 110 positions print media 118 relative to printhead 114.

Electronic controller 104 typically includes components of a standard computing system such as a processor, memory, machine readable instructions, and other printer electronics for communicating with and controlling supply device 108, printhead 114, mounting assembly 106, and media transport assembly 110. Electronic controller 104 receives data 122 from a host system, such as a computer, and temporarily stores the data 122 in a memory. Data 122 represents, for example, a document and/or file to be printed. Thus, data 122 forms a print job for inkjet printing system 100 that includes print job commands and/or command parameters. Using data 122, electronic controller 104 controls printhead 114 to eject ink drops from nozzles 116 in a defined pattern that forms characters, symbols, and/or other graphics or images on print medium 118.

FIG. 2 shows an example of a fluid supply device 108 implemented as an ink cartridge 108. The ink cartridge supply device 108 generally includes a cartridge body 200, printhead 114, and electrical contacts 202. Individual fluid drop generators within printhead 114 are energized by electrical signals provided at contacts 202 to eject fluid drops from selected nozzles 116. The fluid can be any suitable fluid used in a printing process, such as various printable fluids, inks, pre-treatment compositions, fixers, and the like. In some examples, the fluid can be a fluid other than a printing fluid. The supply device 108 may contain its own fluid supply within cartridge body 200, or it may receive fluid from an external supply (not shown) such as a fluid reservoir connected to device 108 through a tube, for example. Ink cartridge supply devices 108 containing their own fluid supplies are generally disposable once the fluid supply is depleted.

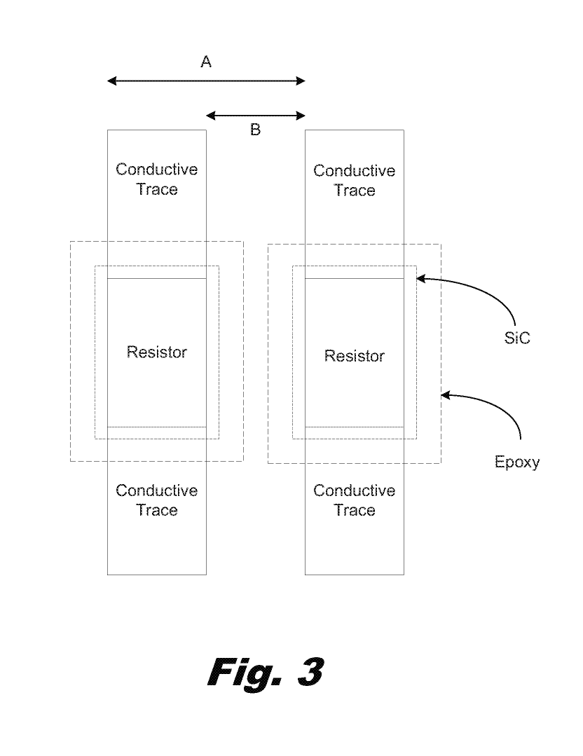

FIG. 3 is a plan view or overhead view of a pair of firing resistors according to one example. The distance A shows the spacing from resistor to resistor and the distance B shows the separation between adjacent traces and resistors. The conductive traces at the top of the figure are connected to associated conductive traces at the bottom of the figure through the resistors. When current is provided to a top conductive trace, it passes through the resistor and through the associated bottom trace, heating the resistor due to the loss across the resistor. The SiC layer covers the surface of the traces and sides of the resistors. The SiC layer is etched back from the top surface of the resistor. This may expose a cavitation barrier layer on the top of the resistor. Alternately, the top of the resistor is exposed or a thermally conductive barrier may cover the resistor. A second dashed line indicates the outline of the epoxy firing chamber. Note the presence of space between the two firing chambers and two SiC encapsulations of the resistors. This indicates the presence of epoxy between the adjacent resistors at the same vertical level as the resistors.

In some examples, distance A is 21 microns (micrometers), In some examples, distance A may be 42 or more microns. Distance B, the separation between adjacent electrically conductive elements, is about 4 to 10 microns. In some examples, the separation between adjacent electrically conductive elements is between about 5 to 7 microns. Increasing distance B provides additional electrical isolation between adjacent conductive elements. However, increasing B also reduces the density of elements on a die, resulting in increased printing times and/or decreased printing resolution.

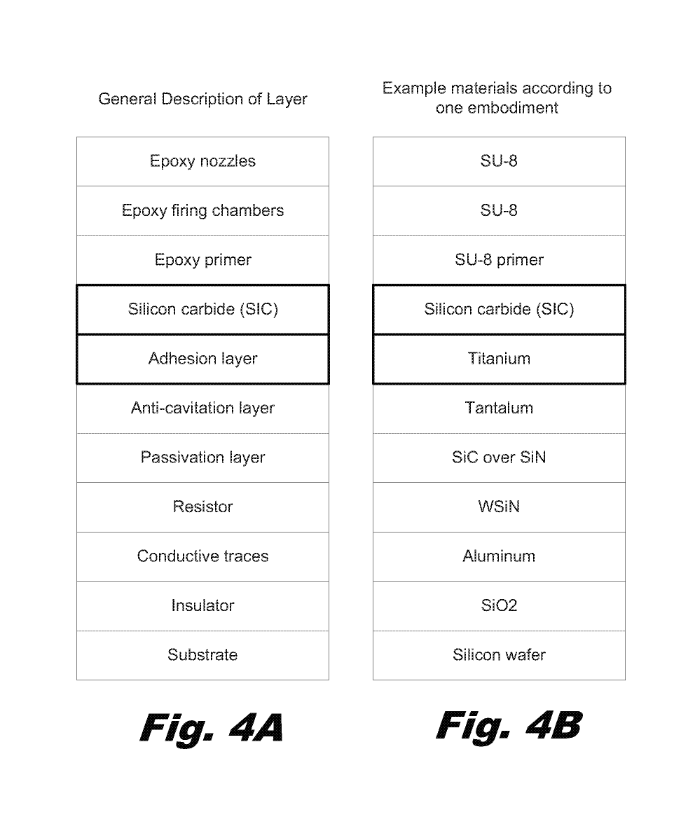

FIGS. 4A and 4B show a partial cross-sectional view of an illustrative TIJ printhead 114 that employs a SiC-only insulating layer. The heights of the elements in the figure do not represent the thicknesses of the respective layers which vary greatly. Instead, the figure indicates one way the layers can be ordered. FIG. 4A provides a general description of each layer, while FIG. 4B shows one specific implementation as an example. Clearly, variations of FIG. 4B consistent with FIG. 4A are covered by the scope of this specification. Similarly, rearrangement of the layers of FIG. 4A that do not impose an additional layer between the adhesion layer and the SiC layer are covered by this specification. For instance, some examples may include an additional conductive layer and insulating layer under the resistor layer. Other examples may include additional layers to form other electronic components or logic elements.

The TIJ printhead includes a substrate made of silicon (Si) or other appropriate material such as glass, a semi-conductive material, various composites, and so on. The thin film stack may include a sealant over the substrate such as a thermally grown field oxide and/or an insulating glass layer deposited, for example, by Plasma Enhanced Chemical Vapor Deposition (PECVD) or other deposition techniques. The sealant may form an oxide underlayer for a thermal resistor layer. Thermal/firing resistors are formed by depositing (e.g., by sputter deposition) a resistor layer 302. The resistor layer 302 is on the order of about 0.1 to 0.75 microns thick and can be formed of various suitable resistive materials including, for example, tantalum aluminum, tungsten silicon nitride, nickel chromium, carbide, platinum, and titanium nitride. Resistor layers having other thicknesses are also within the scope of this specification.

A conductive layer is deposited (e.g., by sputter deposition techniques) on the resistive layer. The deposited material is then patterned (e.g., by photolithography) and etched to form conductor traces and resistors. Etching may be performed after each layer is deposited or may be performed simultaneously on the conductor/resistor layers. Conductive traces can be made of various materials including, for example, aluminum, aluminum/copper alloy, copper, gold, and so on. Alternately, the conductive layer can be formed and patterned first, followed by the forming of the resistor elements by deposition and patterning.

Additional overcoat layers can be formed over the resistor to provide additional structural stability and/or electrical insulation from fluid in the firing chamber. Overcoat layers are generally considered to be part and parcel of the resistor, and, as such, they provide a final component of the resistor. Overcoat layers may include an insulating passivation layer formed over the resistor and the conductor traces to prevent electrical charging of the fluid or corrosion of the device in the event that an electrically conductive fluid is used. A passivation layer has a thickness on the order of about 0.1 to 0.75 microns, but may have other thicknesses, and may be formed (e.g., by sputtering, evaporation, PECVD) of suitable materials such as silicon dioxide, aluminum oxide, silicon carbide, silicon nitride, and glass.

Overcoat layers may also include a cavitation barrier layer over the passivation layer that helps dissipate the force of the collapsing drive bubble left in the wake of each ejected fluid drop. The cavitation barrier layer has a thickness on the order of about 0.1 to 0.75 microns, but it may also have a greater or lesser thickness. The cavitation barrier layer is often, but not necessarily, formed of tantalum deposited by a sputter deposition technique.

The next set of layers is referred to as die surface optimization (DSO) and provide an adherent barrier layer that facilitates adhesion between the metalized die and subsequent epoxy layers. The DSO includes a thin adhesion layer provided over the surface and a SiC insulating layer. The adhesion layer is applied over the surface to facilitate adhesion of the insulating layer. The adhesion layer may comprise titanium, which has good adhesion to the materials described above and notably adheres well to gold. The adhesion layer may be between about 200 and 1500 angstroms thick (0.02 and 0.15 microns respectively). In other examples, the adhesion layer is between 300 and 800 angstroms thick (0.03 and 0.08 microns). In other examples, the adhesion layer is between about 400 and 600 angstroms thick (0.04 and 0.06 microns).

As discussed above, some processes have provided a coating of SiN over the adhesion layer. The SiN layer was then coated with a SiC layer. For instance, the SiN layer may have been about 100 to 50,000 angstroms (0.01 to 5 microns) thick with a SiC overcoat of about 4,000 to 21,000 angstroms (0.4 to 2.1 microns). The SiN coating provides dielectric breakdown protection and keeps leakage currents low. However, because of the thickness of the combined coating, either the element to element separation is increased or the coating between adjacent elements overlaps such that epoxy cannot penetrate between adjacent elements. In one example, the coating does not allow elements to be fully coated with an element to element separation of 6 microns, such that there is no epoxy located between respective elements with the SiN/SiC coating.

In the present specification, the DSO layer is formed directly onto the resistor and the conductor traces to prevent electrical charging of the fluid or corrosion of the device (as mentioned above, the cavitation barrier layer is considered part of the resistor). A passivation layer has a thickness on the order of about 0.1 to 4 microns. In some examples, the passivation layer has a thickness between 0.5 to 1.2 microns. The SiC insulating layer occupies space between adjacent resistors and conductive traces, electrically isolating them. In one example, the minimum spacing between elements is 6 microns. In another example, the minimum spacing between elements is 4, 8, or 10 microns. Larger spacing provides greater insulation and lower leakage currents between adjacent elements. However, larger spacing also results in greater footprint on the substrate and reduced density. Accordingly there is a tradeoff between element density and leakage current. This tradeoff is also impacted by the dielectric properties of the insulating passivation layer as well as the conformance and ability to prevent pinholes and similar defects. Finally, the tradeoff is impacted by the voltages between the neighboring elements, with higher voltage differentials providing greater leakage current. The passivation layer may be selectively etched back to provide better or direct contact between the cavitation barrier layer and the fluid in the ejection chamber.

SiN films are reported to have a dielectric breakdown voltage of approximately 3-8 MV/cm. (Source: “Electrical breakdown voltage characteristics of buried silicon nitride layers and their correlation to defects in the nitride layer”, Materials Letters, Volume 9, Issues 7-8, April 1990, Pages 252-258). SIC films are reported to have a dielectric breakdown voltage of 3 MV/cm. (Source: rohmfs.rohm.com/en/products/databooklapplinote/discrete/sic/common/sic_app li-e.pdf). SU-8 (an epoxy) is reported to have dielectric breakdown voltages of approximately 4 MV/cm however reports show significant variation and may depend on cure conditions. (Source: memscyclopedia.org/su8.html). In practice, thin SiC films show greater charge permeability than the thicker combination of SiN/SiC films. Dielectric breakdown strength in polymers and polymer films is impacted by thickness and defects despite the fact that it is generally reported on a per thickness basis. Similarly, there appears to be time dependence in breakdown, such that longer periods at a given voltage may produce breakdown even when shorter periods at higher voltages do not. Accordingly, the short time pulses used in the printhead may be conservative compared with standard test methods, such as ASTM D149-09(2013) which use longer periods of voltage application.

The thinner SiC-only layer described herein may allow improved precision in forming the epoxy elements on top of the SiC insulating layer. The resolution of the epoxy masking and developing process is dependent upon a number of different factors. For instance, while a theoretical point source would reduce the penumbra of partial cure, in practice, light or ultraviolet (UV) sources are not point sources, but have a real fixed width. Similarly, the light from the source can be collimated by increasing the separation between the source and the epoxy. However, the further the distance, the greater the amount of light that is absorbed non-productively by the system and not used to react the epoxy. Generally, this relationship is governed by the 1/R̂2 relationship. Accordingly, there are practical limits to the amount of collimation obtained such that a portion of the curing light will be at an angle off from orthogonal to the surface of the wafer/die.

A collimated beam of light, such as a laser, can be used for curing operations but doing so significantly increases the costs and processing time. Similarly an e-beam provides another alternative with increased cost and throughput restrictions. As a result, real world applications of photon activated resins (including UV or near UV activated resins) depend on the width of the source and separation of the source from the mask. In theory, the mask to epoxy separation impacts the resolution, but, in practice, it is generally minimized to reduce the amount of partially cured epoxy on the edges of the mask.

In practice, without the DSO layer, the light can pass through the developing epoxy and scatter off the metallic elements, such as the tantalum cavitation barrier layer or the conductive traces. The reflected or scattered light can be absorbed by the epoxy in areas that are not intended for exposure, resulting in irregular edges to the formed epoxy structures and/or difficulty in removing portions of the epoxy. Some epoxies use a thermal cure cycle to propagate the photo initiated reactions. Thermal cured epoxies may have rounder edges than purely photo cured epoxy layers.

Limiting the thickness of the DSO coating reduces the amount of scatter. Even in a perfectly level substrate, there exists some angle offset between a portion of the light and the orthogonal direction relative to the substrate (due to the width of the light source and the less than infinite separation between the light source and the mask). The further the light travels from the mask to the reflector, the further it spreads laterally from the ideal mask template. If the light reflects, it can then double this lateral spread before contacting the mask or passing out of the system. Accordingly, the use of a thinner insulating layer allows tighter control of the geometry of the epoxy elements. Alternately, the use of a thinner insulating layer allows the forming of thicker layers of epoxy with the same tolerance and/or reducing the number of masking/curing cycles used to build up a given thickness of the epoxy features. The relative contribution of the DSO thickness increases with thinner epoxy layers and the absolution lateral spread decreases with thinner epoxy layers. Accordingly, optimization of the epoxy layer thickness depends on the thickness of the DSO layer and the acceptable lateral spread of crosslinking during cure.

Deposition of the SiC can be accomplished using the same deposition parameters used with depositing the SiC portion of an SiN/SiC layer. However, because the thickness is less, there may be greater impact of the substrate on the morphology of the SiC.

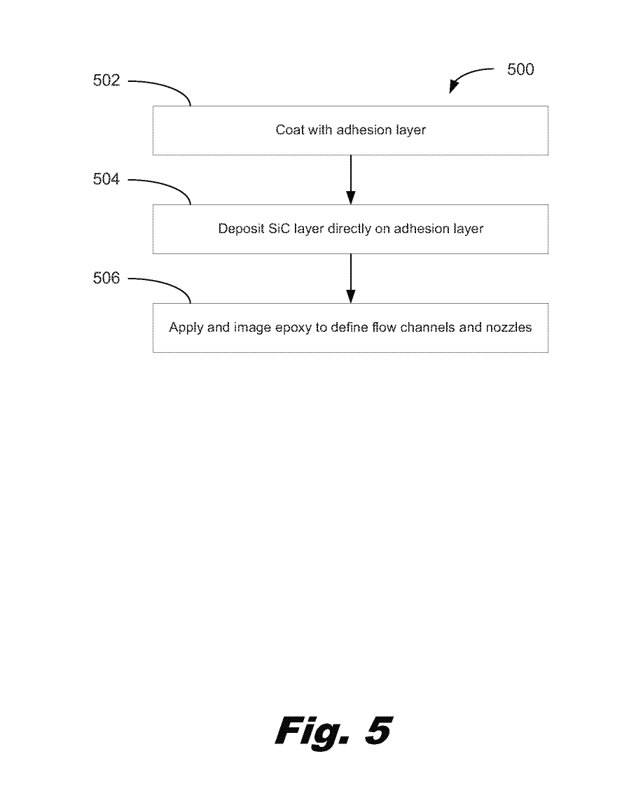

FIG. 5 shows an example of a process 500 for making the device according to one example as described.

Process 502 includes depositing an adhesion layer on top of the formed components including resistors that will function as firing resistors. In one example, the adhesion layer is 300 to 1500 angstroms of titanium.

Process 504 includes depositing a silicon carbide layer directly over the adhesion layer.

Process 506 includes forming the epoxy elements over the silicon carbide layer. This includes applying and imaging the epoxy. The epoxy elements may include the firing chambers, fluid distribution channels to provide printing fluid to the firing chambers, and nozzles.

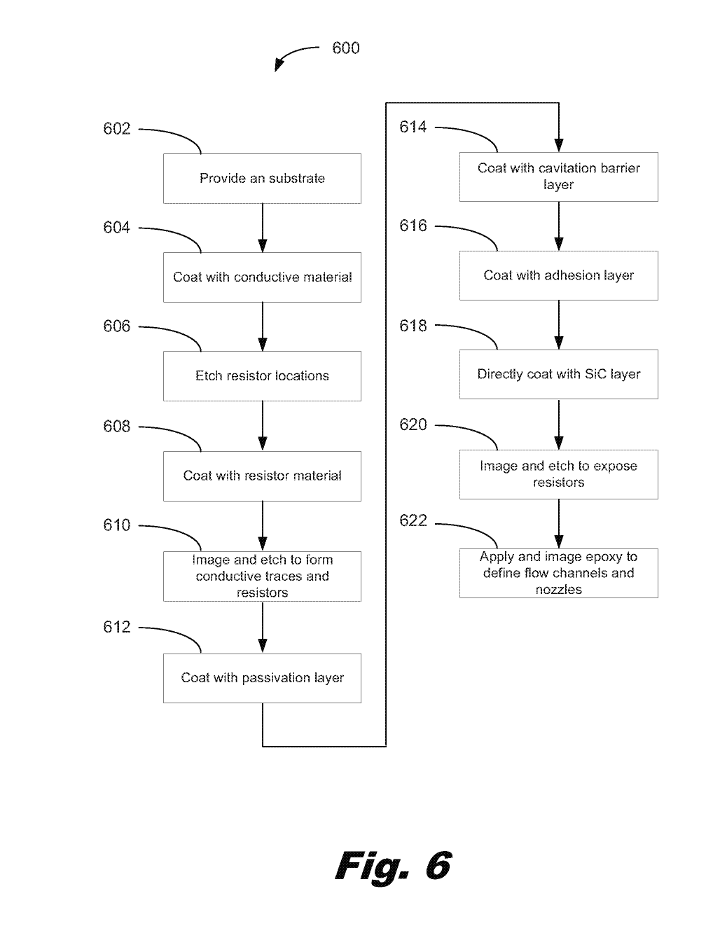

FIG. 6 shows an example of a process 600 for making the device according to another example.

Process 602 includes providing a substrate to form a base on which to build up the layers of a device. The substrate may be a simple non-conductive material as described previously. The substrate may be a silicon oxide formed on a silicon wafer. The substrate may be more complex or have additional layers and functionality below. For example, a substrate may consist of a silicon wafer with an oxide layer, a conductive layer, and a second insulating layer.

Process 604 includes depositing a conductive metal film over a substrate. For example, this may be aluminum, a precious metal group metal, or an alloy.

Process 606 includes imaging and etching openings in the metal film where resistors will be formed.

Process 608 includes coating the conductive film and etched openings with resistor material. For example, this may be tungsten-silicon-nitride (WSiN).

Process 610 includes imaging and etching the conductive traces and resistors.

Process 612 includes depositing a passivation layer. For example, this may be a SiN/SiC layer.

Process 614 includes depositing a cavitation barrier layer. For example, this layer may be formed with sputtered tantalum.

Process 616 includes coating with an adhesion layer. For example, this layer may be formed with sputtered titanium.

Process 618 includes coating the adhesion layer with a thin SIC layer. This layer may be less than 2 microns thick. In some examples, the SiC layer is less than 1 micron thick. For example, the SIC may be approximately 8000 angstroms thick (0.8 microns).

Process 620 includes imaging and etching to remove the SIC from over firing resistors

Process 622 includes applying and imaging epoxy or another material to build up and define the flow channels, firing chambers, nozzles, and similar structures needed for a functioning inkjet. In one example, the material is SU-8 epoxy.

It will be recognized that, within the principles described by this specification, a vast number of variations exist. It should also be recognized that the examples described are just examples, and are not intended to limit the scope, applicability, or construction of the claims in any way.

What is claimed is:

1. A fluid ejection device with an adhesion and insulation layer, the device comprising:
a substrate;
a plurality of resistors on the substrate with separation of between 4 and 8 microns between adjacent resistors;
an adhesion layer applied over the plurality of resistors; and
a layer of silicon carbide (SiC) applied directly over the adhesion layer such that the silicon carbide is between adjacent resistors.

2. The device of claim 1, wherein the layer of silicon carbide is less than 2 microns thick.

3. The device of claim 2, wherein the layer of silicon carbide is less than 1 micron thick.

4. The device of claim 1, comprising a layer of epoxy applied directly over the layer of silicon carbide.

5. The device of claim 4, wherein the layer of epoxy occupies space between adjacent resistors.

6. A method of forming a fluid ejection device with an adhesion and insulation layer, the method comprising:
forming resistors and conductive traces attached to a substrate;
depositing an adhesion layer over the resistors;
depositing a silicon carbide (Sic) coating directly over the adhesion layer; and
forming an epoxy layer over silicon carbide layer.

7. The method of claim 1, wherein the adhesion layer is 300 to 1500 angstroms of titanium.

8. The method of claim 1, wherein the epoxy layer comprises firing chambers.

9. The method of claim 1, wherein adjacent resistors are separated by 4 to 8 microns.

10. The method of claim 1, wherein the epoxy layer is between adjacent resistors.

11. A printhead with an adhesion and insulating layer for a printer, the printhead comprising:
a silicon substrate;
firing resistors built up on the silicon substrate with a separation of 4 to 8 microns between adjacent firing resistors, the firing resistors comprising a cavitation barrier layer of tantalum;
an adhesion layer applied directly over the cavitation barrier layer;
a silicon carbide (SiC) layer applied directly over the adhesion layer; and
an epoxy layer comprising firing chambers applied over the silicon carbide layer.

12. The printhead of claim 11, wherein the adhesion layer is titanium.

13. The printhead of claim 11, wherein space between adjacent firing resistors is occupied by silicon carbide and epoxy.

14. The printhead of claim 11, wherein the silicon carbide layer is less than 2 microns in thickness.

15. The printhead of claim 14, wherein a thickness of the silicon carbide layer is less than a thickness of the resistors.
